(19) United States
(12) Patent Application Publication
(10) Pub. No.: US 2017/0003373 A1
(43) Pub. Date: Jan. 5, 2017

(54) METHOD AND APPARATUS TO IMPROVE POSITION ACCURACY FOR WI-FI TECHNOLOGY

(71) Applicant: lNTEL IP CORPORATION, Santa Clara, CA (US)

(72) Inventors: Leor BANIN, Petach Tikva (IL); Yuval AMIZUR, Kfar Saba (IL); Uri SCHATZBERG, Kiryat Ono (IL)

(73) Assignee: lntel IP Corporation, Santa Clara, CA (US)

(21) Appl. No.: 15/039,723

(22) PCT Filed: Dec. 26, 2013
(86) PCT No.: PCT/US2013/077795

§ 371 Date: May 26, 2016

(51) Int. Cl. G01S 5/02; G01S 5/14

(52) U.S. Cl. CPC G01S 5/021; G01S 5/14

(57) ABSTRACT

The disclosure generally relates to a method, system and apparatus for calibrating a wireless device for accurate Time-of-Flight (ToF) range determination. In one embodiment, the disclosure provides a method for calibrating a device by identifying a plurality of access points (APs) at the device; identifying a first AP of the plurality of APs, the first AP positioned immediately above the device; determining a real-time ToF value for the first AP; determining a device calibration coefficient from the real-time ToF value for first AP. The disclosed method has many advantages, including simplicity and scalability. Further, the device need not know its location, its distance between from the AP or the AP's identity.

### BACKGROUND

Field

The disclosure relates to a method, apparatus and system to improve position determination of a mobile device. Specifically, the disclosure relates to a method, apparatus and system to accurately determine position of a Wi-Fi device.

Description of Related Art

Outdoor navigation is widely deployed due to advancement in various global positioning systems (GPS). Recently, there has been an increased focus on indoor navigation and position location. Indoor navigation differs from the navigation because the indoor environment precludes receiving GPS satellite signals. As a result, effort is now directed to solving the indoor navigation problem. This problem does not have a scalable solution with satisfactory precision.

A solution to this problem may be based on the Time-of-Flight (ToF) method. ToF is defined as the overall time a signal propagates from the user to an access point (AP) and back to the user. This value can be converted into distance by dividing the signal's roundtrip travel time by two and multiplying it by the speed of light. This method is robust and scalable but requires significant hardware changes to the Wi-Fi modem and other devices. The ToF range calculation depends on determining the precise signal receive/transmit times. As little as 3 nanoseconds of discrepancy will result in about 1 meter of range error.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is an exemplary environment for implementing an embodiment of the disclosure;

FIG. 2 is a schematic illustration of a sequence diagram according to one embodiment of the disclosure;

FIG. 3 schematically illustrates an implementation of the sequence diagram of FIG. 2;

FIG. 4 schematically illustrates an exemplary device for implementing an embodiment of the disclosure;

FIG. 5 schematically illustrates a system according to an embodiment of the disclosure; and

FIG. 6 is an exemplary flow diagram for implementing an embodiment of the disclosure.

### DETAILED DESCRIPTION

Conventional radio devices have components including: antenna(s), analog section and digital domain. The antenna transmits and/or receives analog signals. The analog section receives the analog signals from the antenna, processes and converts the analog signal to a digital data stream. The digital data is then processed through the digital domain to extract information contained in the signal. A measurable delay exists from the time the antenna receives a signal to the time the signal is received and processed at the digital domain. The delay is caused by the processing delay inherent in all electronic components as well as the process variation in the analog circuitry. Each unit has different delays between its antenna and digital domain. The delay is present regardless of manufacturer or model. The delay may vary among devices of the same make and model.

For accurate time and range measurements, such delays must be identified and compensated through a calibration process. Typically, the delay variability ranges are few nanoseconds up to a few dozens of nanoseconds, resulting in range and/or positioning error of few meters or more. The position inaccuracy can be significant in indoor environments where walls or other obstacles exist. Calibrating each device during manufacturing is complex, time consuming and expensive.

According to one embodiment of the disclosure, a more accurate ToF measurement is the time it takes for a signal to travel from an AP antenna to a device which is calibrated for device processing delay. Thus, in one embodiment of the disclosure, the device delay is quantifiably measured and used to determine device calibration coefficient. The device and device operator (i.e., devices user) can be positioned immediately below an AP. The operator need not know which AP is positioned above or the AP's location. This will improve performance for time, range and location measurements. The calibration coefficient is then used to eliminate device-specific errors thereby determining accurate device location. The disclosed embodiments are significantly less complex than the conventional methods because the device does not have to determine its location nor the distance between the device and the AP. Further, AP's identity is not needed to calibrate the device. The disclosed embodiment is fundamentally more accurate because when the AP is immediately above the device the transmitter-to-receiver distance is very small. Consequently, the channel has less multipath interference diminishing the ToF accuracy. The proximity between the AP and the device provides an accurate ToF resolution.

According to another embodiment, the disclosure relates to a wireless device in communication with several APs. The device determines a ToF value with respect to each of the APs. In addition, each AP performs its own measurements with all other APs to provide measurements for each AP pair. Using the AP pair measurement information, the device (or a remote server) can calibrate both the device and all APs. In one embodiment, at least 3 APs are used for AP pair ToF measurements.

In still another exemplary embodiment, a new message is sent to a the Wi-Fi ToF controller in a mobile device. The user can send a message that the device is immediately below (or substantially beneath) an AP and is seeking to calibrate the device. The AP may be unknown to the device. Once the controller receives the message, it performs range measurements for all neighboring APs and determines which AP, of the cluster of nearby APs, is above the user. This can be done by selecting the AP closest to the user (if the user and the AP locations are known) or by selecting the AP which has the highest visible received signal strength indicator (RSSI) to the device.

After identifying the AP, the controller will perform several range measurements to the identified AP. The controller can process all range measurements and estimate a calibration coefficient for the device. The controller can save the calibration coefficient to a memory for future use. Once the calibration coefficient is known, the same steps may be repeated for the neighboring APs (from the same position). In one embodiment, this step is implemented if the AP is also calibrated. By obtaining more calibrations from more APs, the device calibration coefficient can be even more accurate. If all APs are not calibrated, range measurement can be conducted from a device to all APs and range measurements can be obtained for all device/AP pairs. This information can then be used to calibrate the device and the AP together. Device-specific and AP-specific offsets for all APs can be determined in this manner.

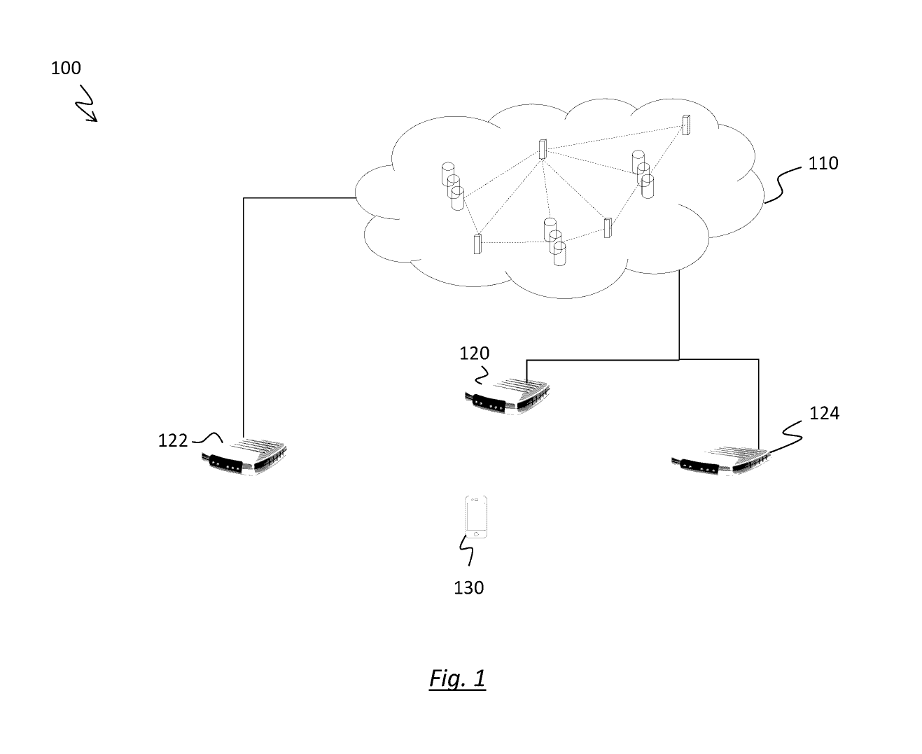

FIG. 1 is an exemplary environment for implementing an embodiment of the disclosure. Environment 100 of FIG. 1 may include a wireless communication network, including one or more wireless communication devices capable of communicating content, data, information and/or signals over a wireless communication medium (not shown). The communication medium may include a radio channel, an infrared (IR) channel, a Wi-Fi channel or the like. One or more elements of environment 100 may optionally be configured to communicate over any suitable wired communication link. Environment 100 may be an indoor environment, an enclosed area or a part of a multi-level structure.

Network 110 of FIG. 1 enables communication between environment 100 and other communication environments. Network 110 may further include servers, databases and switches. Network 110 may also define a cloud communication system for communicating with APs 120, 122 and 124. While environment 100 may have many other APs, for simplicity only APs 120, 122 and 124 are illustrated in FIG. 1. Communication between the APs and network 110 may be through a wireless medium or a through direct connection. Further, the APs may communicate with each other wirelessly or through landline. Each AP may be directly linked to cloud 110, or it may communicate with cloud 110 thought another AP (a relay switch). Each AP may define a router, a relay station, a base station or any other device configured to provide radio signal to other devices.

Communication device 130 communicates with APs 120, 122 and 124. Communication device 130 may be a mobile device, a laptop computer, a tablet computer, a smartphone, a GPS or any other portable device with radio capability. While the embodiment of FIG. 1 shows device 130 as a wireless laptop, the disclosure is not limited thereto and device 130 may define any device seeking its position within an environment.

During an exemplary implementation, device 130 scans environment 100 to identify APs 120, 122 and 124. A software program or an applet (App) may be used for this function. Scanning may occur continuously or after a triggering event. The triggering event can be receipt of a new beacon signal, turning on device 130 or upon opening or updating a particular App. Alternatively, scanning can occur during regular intervals (e.g., every minute).

Once scanned, device 130 may identify each of APs 120, 122 and 124. Device 130 may measure the signal strength for each AP and identify the AP with the strongest RSSI. Positioning device 130 immediately under AP 120 provides identical x and y Cartesian coordinates for AP 120 and device 130. Consequently, multipath signal propagation will be minimized, if not entirely eliminated. It should be noted that while device 130 is shown immediately below AP 120, the disclosed embodiments are not limited thereto and can be applied when AP 120 and device 130 are positioned proximate to each other so as to substantially eliminate signal multipath.

Because of its proximity to device 130, the RSSI value for AP 120 will be higher than the RSSI values for APs 122 and 124. Once AP 120 is appropriately identified, device 130 can measure a real-time Time-of-Flight (ToF) value for AP 120 (interchangeably, first AP). Device 130 may compare the real-time ToF value with an expected ToF value to determine an offset value. The offset value can define device calibration coefficient. By way of example, if the expected distance between the device and the AP is 1 m. and the measured distance is 1.5 m., then the calibration coefficient can be 0.5 m. Alternatively, the distance can be transformed into time domain by dividing 0.5 m by the speed of light. This value can be added or removed from ToF time measurement. ToF time measurement can be converted to distance by multiplying it by the speed of light.

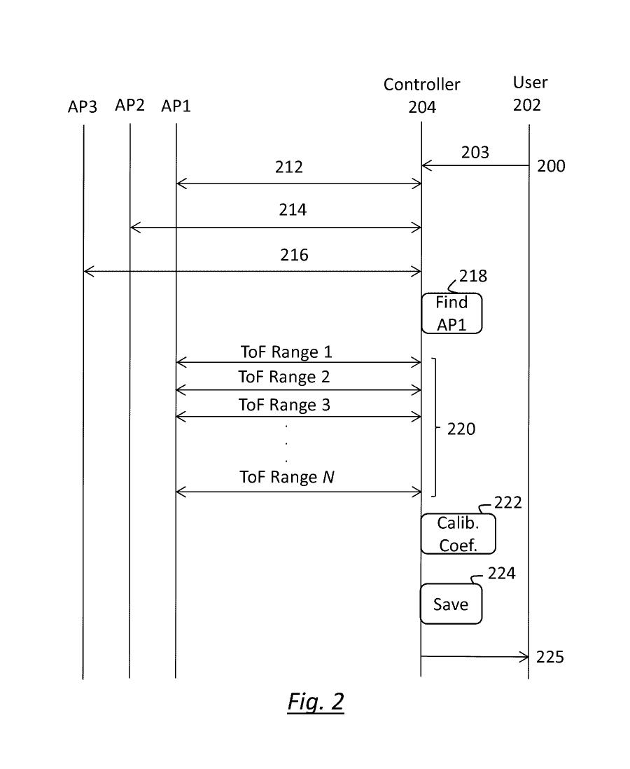

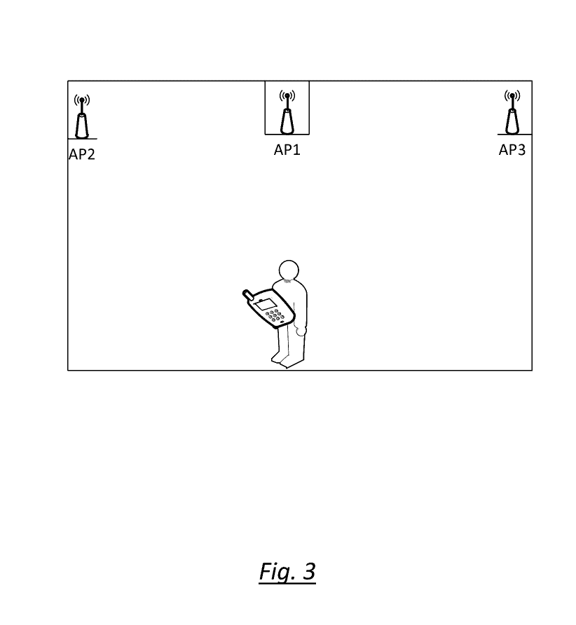

FIG. 2 is a schematic illustration of a sequence diagram according to one embodiment of the disclosure. The process of FIG. 2 starts at step 200. User 202 (interchangeably, operator) has control of the wireless device with Wi-Fi controller 204. At step 203, the Wi-Fi controller 204 is positioned immediately below an AP and scans for available APs. Upon scanning, AP1, AP2 and AP3 may be identified (see FIG. 3 and related discussion below). While it is known that user 202 and the wireless device are positioned immediately below an AP, the identity and location of the AP may be unknown to controller 204.

At steps 212, 214 and 216, Wi-Fi controller 204 calculates ToF range or distance between the device and each of AP1, AP2 and AP3. Based on the calculated ToF ranges, at step 218, Wi-Fi controller 204 determines that AP1 is positioned substantially immediately above, or very proximal to, the wireless device. At step 220, Wi-Fi controller 204 obtains N ToF range values for AP1. An average or median value of the ToF range values may be used to determine device calibration coefficient at step 222. While the exemplary embodiment of FIG. 2 determines device calibration coefficient as a function of an average value for N range calculations, the disclosure is not limited thereto. The ToF range value may be determined from only one measurement. The ToF range value may be selected as the lowest of the N range value measurement. In another alternative, the lowest and the highest of the N range measurement values may be discarded as outliers. The remaining ToF range measurements can be used to calculate an average ToF range value.

At step 224, the device calibration coefficient is stored for future use. At step 225, the process ends. While not shown, the device calibration coefficient may be communicated with an external server (e.g., a cloud server) so that the device calibration coefficient may be calculated and/or saved externally. While not shown, further ToF range calculations can be made with each of AP2 and AP3 after the device calibration coefficient is obtained. The device calibration coefficient reduces error in location measurement for AP2 and AP3.

FIG. 3 schematically illustrates an implementation of the sequence diagram of FIG. 2. Here, the wireless device is positioned immediately below AP1. The wireless device is also capable of scanning and receiving signals from each of AP2 and AP3. Because the wireless device and AP1 share the same x-y coordinates, the only variation is in the vertical or z-axis. Accordingly, the ToF range calculation is not affected by multipath signals from AP1. Once device calibration coefficient is determined through ToF range calculation between AP1 and the wireless device, range calculation can be made for each of AP2 and AP3.

The method of FIGS. 2 and 3 is an efficient method for calibrating a wireless device because the user does not need to know its position, the distance between AP1 and the wireless device or the AP's identity and address. The calibration process is also more accurate than conventional processes because the only difference in location is in the vertical distance (z-axis). Because of its simplicity, the calibration procedure can be performed many times by the user each time the wireless device is positioned immediately below an AP. The disclosed procedure can also be performed from the same location with all neighboring APs to obtain a more accurate device location.

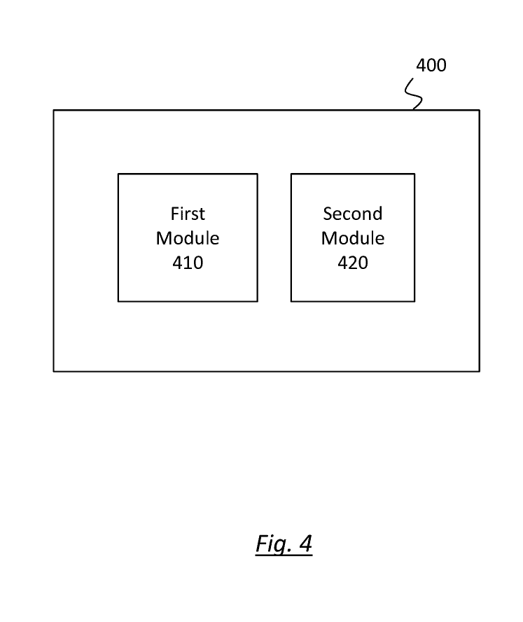

FIG. 4 schematically illustrates an exemplary device for implementing an embodiment of the disclosure. Specifically, FIG. 4 shows device 400 which can be an integral part of a larger system or can be a stand-alone unit. For example, device 400 can define a system on chip configured to implement the disclosed methods. Device 400 may also be part of a larger system having multiple antennas, a radio and a memory system. Device 400 is shown with first module 410 and second module 420. Modules 410 and 420 can be hardware, software or a combination of hardware and software. Further, each of module 410 and 420 can define one or two independent processor circuits. Modules 410 and 420 may having sub-modules configured to perform discrete tasks. In an exemplary embodiment, at least one of modules 410 or 420 includes a processor circuit and a memory circuit (not shown) to communicate with each other.

In another embodiment, modules 410 and 420 define different parts of the same data processing circuit. While not shown, other discrete or independent modules may be added to implement the embodiments disclosed herein. Further, modules 410 and 420 may be combined to form an integrated unit.

Device 400 may be a software residing at a processor within a wireless device. In this manner, device 400 can be configured to operate within the operation parameters of the wireless device. For example, once a first AP positioned immediately above the wireless device is identified, first module 410 can conduct a real-time ToF measurement between the wireless device and the first AP. Second module 420 can be configured to determine a device calibration coefficient from the real-time ToF value for first AP. Alternatively, module 410 can be configured to scan the airways and identify all observable APs. The module then ranks the APs based on their RSSI. Module 410 may be configured to identify the AP immediately above it (first AP), or device 400 can receive a message identifying an AP substantially immediately above device 400. Module 410 may be triggered to repeat the disclosed steps each time it is immediately under an AP.

Module 420 can be configured to measure a ToF range value for the first AP. Module 420 can cause a signal to be transmitted to first AP and measure the signal's roundtrip time to obtain ToF range value for the first AP. Module 420 may direct several ToF range measurement for the first AP to ascertain an average range value as discussed above. Once the ToF range is calculated, module 420 can determine the device calibration coefficient as a function of the expected ToF range and the measured ToF range. In an exemplary embodiment, device 400 can be configured to repeat the ToF measurement to three other APs to determine its calibrated position.

Module 420 may store the device calibration coefficient locally and/or at a remote memory. Module 420 can use the calibration coefficient for all future range measurements. Module 420 may also be configured to perform additional tasks, including ToF range measurement for other APs as a function of the device calibration coefficient.

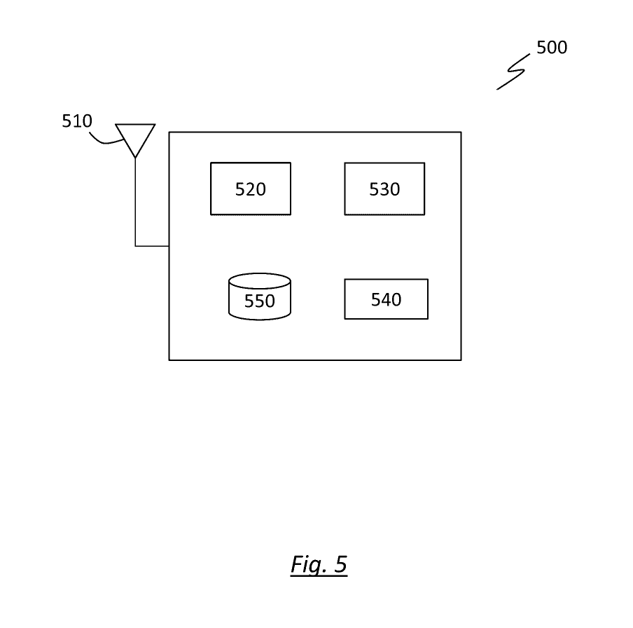

FIG. 5 schematically illustrates a system according to an embodiment of the disclosure. While other components may be included in system 500, for brevity, system 500 is shown with antenna 510, front-end radio 520, digital domain 530, ToF controller 540 and database 550. Device 500 may be any device configured to determine its position. For example, device 500 may define a smartphone, a tablet computer, a laptop computer, a GPS device or a radio.

Antenna 510 may represent one or a bank of antennas where each antenna is configured to process a different incoming signal protocol. Radio front-end 520 may include components necessary to receive and process analog signals. For example, front-end 520 may define an RF front-end including circuitry between antenna 510 and digital domain 530. The digital domain may comprise digital data processing portion of the system. By ways of example, front-end 520 may include an impedance matching circuit to match the input impedance of the receiver with antenna 510 such that the maximum power is transferred from antenna 510, band-pass filter(s) to reduce strong out-of-band signals and image frequency response and an RF amplifier to amplify weak signals.

Digital domain 530 receives the sampled signal in digital format and processes the information extracted from the incoming signal. ToF controller 540 can be configured to conduct ToF range calculations according to the disclosed embodiments. Namely, ToF controller 540 can identify a plurality of APs from their respective RSSIs, identify an AP immediately above system 530 and determine the calibration coefficient for system 530.

ToF controller 540 can communicate with other components of system 530 to determine the lag between receiving a signal at antenna 510 and receiving signal information at digital domain 530. This lag time enables device calibration coefficient determination. Database 550 can be a static or dynamic memory module for storing information including the calibration coefficient. Once stored, database 550 can provide the calibration coefficient to ToF controller 540 for future ToF measurement. Database 550 may also include instructions to direct ToF Controller 540 to implement steps necessary to determine a system calibration coefficient.

In one exemplary embodiment, database 550 comprises a memory circuit and ToF Controller 540 comprises a processor circuit in communication with the memory circuit. Memory circuit 550 may retain instructions to direct ToF controller 540 to (1) receive a plurality of RSSIs corresponding to a plurality of APs, (2) identify a first AP positioned immediately above system 500, (3) determine a system calibration coefficient, (4) store or update memory 550 with the new calibration coefficient, and (5) conduct new ToF measurements as a function of the new calibration coefficient.

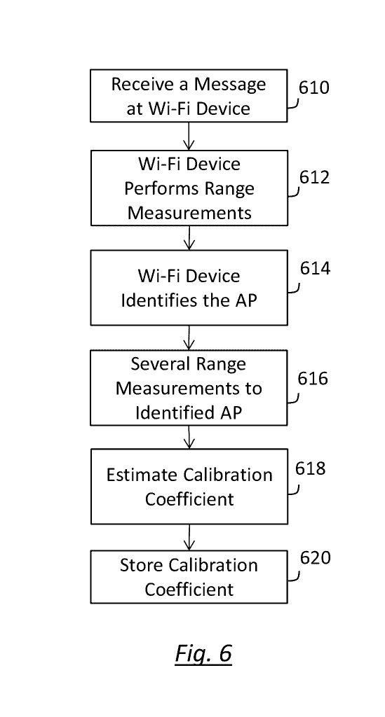

FIG. 6 is an exemplary flow diagram for implementing an embodiment of the disclosure. At step 610, the wireless device sends a message through an interface with the AP indicating that the device would like to calibrate itself. The message may indicate that the device is positioned immediately below an AP (the first AP). The first AP's response may be received at the Wi-Fi device. The response may be directed to the Wi-Fi ToF Controller associated with the device. In the event that the first AP is not immediately identified, at step 612, the Wi-Fi controller performs range measurements to all observable APs. As a result of the range measurements, at step 614, the Wi-Fi controller identifies one of observable APs (i.e., the first AP) as the AP substantially immediately above the device.

At step 616, several more range measurements are performed for the first AP. Step 616 may be optional if a ToF range value was previously obtained, for example, at step 612. At step 618, the Wi-Fi controller estimates, either directly or indirectly, a calibration coefficient for the wireless device. The calibration coefficient is stored at step 620 for future use.

The following examples pertain to further embodiments of the disclosure. Example 1 is directed to a method for device calibration, the method comprising: identifying a plurality of access points (APs) at a device; selecting a first AP of the plurality of APs, the first AP positioned immediately above the device; determining a real-time Time-of-Flight (ToF) value for the first AP; determining a device calibration coefficient from the real-time ToF value for the first AP.

Example 2 is directed to the method of Example 1, further comprising receiving a plurality of signals at the deice, each of the plurality of received signals corresponding to one of a plurality of APs communicating with the device.

Example 3 is directed to the method of Example 1 or 2, wherein the real-time ToF value is determined as a function of a signal received from the first AP.

Example 4 is directed to the method of Example 1 or 2, wherein the real-time ToF value is determined as an average value for a plurality of signals received from the first AP.

Example 5 is directed to the method of Example 1, further comprising determining the device calibration coefficient by calculating the difference between an expected ToF value and the real-time ToF value.

Example 6 is directed to the method of Example 1, further comprising determining a real-time ToF value for a second of the plurality of APs.

Example 7 is directed to the method of Example 6, further comprising determining a device location as a function of the device calibration coefficient and a real-time ToF value between the device and the second AP.

Example 8 is directed to the method of Example 1, wherein identifying a first AP further comprises receiving an indication from the device that the first AP is positioned immediately above the device.

Example 9 is directed to the method of Example 1, further comprising obtaining a location for the first AP through an interface with the first AP.

Example 10 is directed to a device comprising: a first module configured to determine a real-time Time-of-Flight (ToF) value between the device and a first access point (AP) positioned above the device; a second module configured to determine a device calibration coefficient from the real-time ToF value and a device location relative to the first AP.

Example 11 is directed to the device of Example 10, wherein the first module is configured to identify a plurality of APs in communication with the device.

Example 12 is directed to the device of Example 10 or 11, wherein at least one of the first module or the second module is further configured to identify an AP immediately above the device.

Example 13 is directed to the device of Example 10, wherein the second module is further configured to estimate a device location as a function of the real-time ToF value and the device calibration coefficient.

Example 14 is directed to the device of Example 10, wherein the second module is further configured to determine the real-time ToF value as an average value of a plurality of signals received from the first AP.

Example 15 is directed to the device of Example 10 or 14, wherein the second module is further configured to determine the device calibration coefficient by calculating the difference between an expected ToF value and the real-time ToF value.

Example 16 is directed to the device of Example 10, wherein the second module is further configured to determine location of the device as a function of the real-time ToF value for a second AP and the device calibration coefficient.

Example 17 is directed to the device of Example 10, wherein the first module is further configured to receive a message identifying the first AP positioned immediately above the device.

Example 18 is directed to the device of Example 10, wherein the first module is further configured to identify the first AP.

Example 19 is directed to a system comprising: one or more antennas;

a radio to communicate with the one or more antennas; a ToF controller to communicate with the radio, the ToF controller configured to determine a real-time ToF value between the radio and a first access point (AP) and to determine a device calibration coefficient.

Example 21 is directed to the system of Example 19, wherein the first AP is positioned immediately above the antenna.

Example 22 is directed to the system of Example 19, wherein the radio comprises an analog receiver and a digital signal processor.

Example 23 is directed to the system of Example 19, wherein ToF controller is further configured to identify an AP immediately above the system.

Example 24 is directed to a computer-readable storage device containing a set of instructions to cause a computer to perform a process comprising: identify a plurality of access points (APs) at a device; selecting a first AP of the plurality of APs, the first AP positioned immediately above the device; determine a real-time Time-of-Flight (ToF) value for the first AP; and determine a device calibration coefficient from the real-time ToF value for the first AP.

Example 25 is directed to the computer-readable storage device of Example 24, wherein the instructions further comprise identifying the first AP as a function of a received signal strength indicator from the first AP.

While the principles of the disclosure have been illustrated in relation to the exemplary embodiments shown herein, the principles of the disclosure are not limited thereto and include any modification, variation or permutation thereof.

1. A method for calibrating a device, comprising:
identifying a plurality of access points (APs) at a device;
selecting a first AP of the plurality of APs, the first AP positioned immediately above the device;
determining a real-time Time-of-Flight (ToF) value for the first AP; and
determining a device calibration coefficient from the real-time ToF value for the first AP.

2. The method of claim 1, further comprising receiving a plurality of signals at the deice, each of the plurality of received signals corresponding to one of a plurality of APs communicating with the device.

3. The method of claim 1, wherein the real-time ToF value is determined as a function of a signal received from the first AP.

4. The method of claim 1, wherein the real-time ToF value is determined as an average value for a plurality of signals received from the first AP.

5. The method of claim 1, further comprising determining the device calibration coefficient by calculating the difference between an expected ToF value and the real-time ToF value.

6. The method of claim 1, further comprising determining a real-time ToF value for a second of the plurality of APs.

7. The method of claim 6, further comprising determining a device location as a function of the device calibration coefficient and a real-time ToF value between the device and the second AP.

8. The method of claim 1, wherein identifying a first AP further comprises receiving an indication from the device that the first AP is positioned immediately above the device.

9. The method of claim 1, further comprising obtaining a location for the first AP through an interface with the first AP.

10. A device comprising:
a first module configured to determine a real-time Time-of-Flight (ToF) value for the device and a first access point (AP) positioned above the device;
a second module configured to determine a device calibration coefficient from the real-time ToF value and a device location relative to the first AP.

11. The device of claim 10, wherein the first module is configured to identify a plurality of APs in communication with the device.

12. The device of claim 10, wherein at least one of the first module or the second module is further configured to identify an AP immediately above the device.

13. The device of claim 10, wherein the second module is further configured to estimate a device location as a function of the real-time ToF value and the device calibration coefficient.

14. The device of claim 10, wherein the second module is further configured to determine the real-time ToF value as an average value of a plurality of signals received from the first AP.

15. The device of claim 10, wherein the second module is further configured to determine the device calibration coefficient by calculating the difference between an expected ToF value and the real-time ToF value.

16. The device of claim 10, wherein the second module is further configured to determine location of the device as a function of the real-time ToF value for a second AP and the device calibration coefficient.

17. The device of claim 10, wherein the first module is further configured to receive a message identifying the first AP positioned immediately above the device.

18. The device of claim 10, wherein the first module is further configured to identify the first AP.

19. A system comprising:
one or more antennas;
a radio to communicate with the one or more antennas;
a Time-of-Flight (ToF) controller to communicate with the radio, the ToF controller configured to determine a real-time ToF value between the radio and a first access point (AP) and to determine a device calibration coefficient.

20. The system of claim 19, wherein the first AP is positioned immediately above the antenna.

21. The system of claim 19, wherein the radio comprises an analog receiver and a digital signal processor.

22. The system of claim 19, wherein ToF Controller is further configured to identify an AP immediately above the system.

23. A computer-readable storage device containing a set of instructions to cause a computer to perform a process comprising: identify a plurality of access points (APs) at a device; selecting a first AP of the plurality of APs, the first AP positioned immediately above the device; determine a real-time Time-of-Flight (ToF) value for the first AP; and determine a device calibration coefficient from the real-time ToF value for the first AP.

24. The computer-readable storage device of claim 23, wherein the instructions further comprise identifying the first AP as a function of a received signal strength indicator from the first AP.
